(19) United States
(12) Patent Application Publication
(10) Pub. No.: US 2024/0236927 A9
(43) Pub. Date: Jul. 11, 2024

(54) RANGING METHOD AND APPARATUS, TERMINAL DEVICE AND STORAGE MEDIUM

(71) Applicant: BEIJING XIAOMI MOBILE SOFTWARE CO., LTD., Beijing (CN)

(72) Inventors: Xiaowei JIANG, Beijing (CN); Wei HONG, Beijing (CN); Lei YU, Beijing (CN)

(73) Assignee: BEIJING XIAOMI MOBILE SOFTWARE CO., LTD., Beijing (CN)

(21) Appl. No.: 18/279,037

(22) PCT Filed: Feb. 26, 2021
(86) PCT No.: PCT/CN2021/078262

§ 371 Date: Aug. 25, 2023

(51) Int. Cl. H04W 64/00; G01S 11/04; H04L 5/00; H04W 48/16

(52) U.S. Cl. CPC H04W 64/003; G01S 11/04; H04L 5/0048; H04W 48/16

(57) ABSTRACT

A ranging method includes: broadcasting, by a first terminal device, a ranging discovery message in response to a ranging service being triggered; receiving, by the first terminal device, a ranging response message sent by a second terminal device based on the ranging discovery message; and performing, by the first terminal device, ranging with the second terminal device based on the ranging response message.

### CROSS-REFERENCE TO RELATED APPLICATIONS

The present application is a U.S. National Stage of International Application No. PCT/CN2021/078262, filed on Feb. 26, 2021, the disclosure of which is incorporated herein by reference in its entirety for all purposes.

### BACKGROUND

Ranging technology mainly determines a distance parameter and/or relative direction parameter between two nodes, e.g., two user equipment (UEs). With the increasing popularity of terminal devices, the demand for the terminal devices to perform ranging is becoming stronger and stronger, and the application of the ranging technology in various fields (e.g., smart home, smart factory, navigation, positioning, etc.) is becoming more and more widespread. When a ranging service is triggered, it is usually necessary to first cause two UEs that are to perform the ranging service to discover each other, such as causing one of the UEs to broadcast a discovery message to discover the other UE.

### SUMMARY

The present disclosure relates to the field of measurement technology, and in particular to a ranging method and apparatus, terminal device and storage medium.

A first aspect of the present disclosure provides for a ranging method. The method includes: broadcasting, by a first terminal device, a ranging discovery message in response to a ranging service being triggered; receiving, by the first terminal device, a ranging response message sent by a second terminal device based on the ranging discovery message; and performing, by the first terminal device, ranging with the second terminal device based on the ranging response message.

A second aspect of the present disclosure provides for a ranging method. The method includes: obtaining, by a first terminal device, an area of interest (AOI) parameter in response to a ranging service being triggered; determining, by the first terminal device, an AOI broadcast area based on the AOI parameter; and broadcasting, by the first terminal device, a ranging discovery message in the AOI broadcast area.

A third aspect of the present disclosure provides for a ranging method. The ranging method includes: receiving, by a second terminal device, a ranging discovery message broadcast by a first terminal device; and sending, by the second terminal device, a ranging response message to the first terminal device.

A fourth aspect of the present disclosure provides for a terminal device. The terminal device includes: a transceiver; a memory; and a processor, connected to the transceiver and the memory, and the processor, through executing a computer-executable instruction in the memory, is configured to control transmitting and receiving of a wireless signal of the transceiver, and is capable of implementing the method described above.

A fifth aspect of the present disclosure provides for a computer storage medium. The computer storage medium stores a computer-executable instruction, when executed by a processor, is capable of implementing the method described above.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate examples consistent with the present disclosure and together with the description serve to explain the principles of the present disclosure.

FIG. 1 is a flow diagram of a ranging method provided by an example of the present disclosure.

FIG. 2 is a schematic structural diagram of a relative position between an observer UE and a target UE provided by an example of the present disclosure.

FIG. 3 is a diagram of a position relationship between a first terminal device and its corresponding AOI broadcast area provided by an example of the present disclosure.

FIG. 4 is a flow diagram of a ranging method provided by another example of the present disclosure.

FIG. 5 is a flow diagram of a ranging method provided by yet another example of the present disclosure.

FIG. 6 is a flow diagram of a ranging method provided by yet another example of the present disclosure.

FIG. 7 is a flow diagram of a ranging method provided by yet another example of the present disclosure.

FIG. 8 is a flow diagram of a ranging method provided by yet another example of the present disclosure.

FIG. 9 is a flow diagram of a ranging method provided by yet another example of the present disclosure.

FIG. 10 is a flow diagram of a ranging method provided by yet another example of the present disclosure.

FIG. 11 is a flow diagram of a ranging method provided by yet another example of the present disclosure.

FIG. 12 is a flow diagram of a ranging method provided by yet another example of the present disclosure.

FIG. 13 is a flow diagram of a ranging method provided by yet another example of the present disclosure.

FIG. 14 is a schematic structural diagram of a ranging apparatus provided by an example of the present disclosure.

FIG. 15 is a schematic structural diagram of a ranging apparatus provided by another example of the present disclosure.

FIG. 16 is a schematic structural diagram of a ranging apparatus provided by yet another example of the present disclosure.

FIG. 17 is a block diagram of a user equipment provided by an example of the present disclosure.

### DETAILED DESCRIPTION

Examples, which are represented in the accompanying drawings, will be described herein in detail. Where the following description relates to the accompanying drawings, the same numerals in the different accompanying drawings indicate the same or similar elements unless otherwise indicated. The implementations described in the following examples do not represent all implementations consistent with the present disclosure. On the contrary, they are only examples of apparatus and methods that are consistent with some aspects of the present disclosure as detailed in the appended claims.

The terms used in the present disclosure are for the purpose of describing particular examples only and are not intended to limit the examples of the present disclosure. The singular forms of “a” and “the” as used in the examples and the appended claims of the present disclosure are also intended to include the plural forms, unless the context clearly indicates other meanings. It should also be understood that the term “and/or” as used herein refers to and includes any or all possible combinations of one or more of the associated listed items.

Although the terms first, second, third, etc., may be used in the examples of the present disclosure to describe various information, such information should not be limited to these terms. These terms are used only to distinguish the same type of information from one another. For example, without departing from the scope of the examples of the present disclosure, the first information may also be referred to as the second information, and similarly, the second information may also be referred to as the first information. Depending on the context, for example, the word “if” as used herein may be interpreted as “in the case of . . . ”, “when . . . ” or “in response to determining.”

The examples of the present disclosure are described in detail below. The examples are shown in the accompanying drawings, where the same or similar symbols throughout indicate the same or similar elements. The examples described below with reference to the accompanying drawings are intended to be used to explain the present disclosure, and are not to be construed as limiting the present disclosure.

The present disclosure proposes a ranging method and apparatus, terminal device and storage medium for solving the problems of low efficiency, low accuracy, high power consumption, and tendency to lead to ineffective ranging of the ranging methods in the related arts. In related arts, the discovery message includes only an application identifier (ID) and a time when the UE was discovered. In this way, the UE broadcasting the discovery message may be able to discover any UE, including some UEs that do not have ranging capabilities or are not in a ranging application area of interest, which may greatly reduce the efficiency and accuracy of ranging, consume high power, and may lead to ineffective ranging. In the ranging method provided in the examples of the present disclosure, the first terminal device broadcasts the ranging discovery message in response to the ranging service being triggered, receives the ranging response message sent by the second terminal device based on the ranging discovery message, and performs ranging with the second terminal device based on the ranging response message. As can be seen, in the examples of the present disclosure, the first terminal device discovers, through broadcasting the ranging discovery message, the second terminal device according to the ranging response message sent by the second terminal device based on the ranging discovery message, and performs ranging with the second terminal device based on the ranging response message. As a result, the first terminal device is able to efficiently discover the second terminal device based on the ranging response message sent by the second terminal device, then the efficiency and accuracy of ranging are improved, the power consumption is reduced, and effective ranging is realized.

The ranging method and apparatus, terminal device and storage medium provided by the present disclosure are described in detail below with reference to the accompanying drawings.

FIG. 1 is a flow diagram of a ranging method provided by an example of the present disclosure. The ranging method is applied to a first terminal device. As shown in FIG. 1, the ranging method may include the following steps 101 to 103.

At step 101, a ranging discovery message is broadcast by a first terminal device in response to a ranging service being triggered. The ranging methods of the examples of the present disclosure may be applied to any user equipment (UE). The UE may be a device that provides voice and/or data connectivity to a user. The UE may communicate with one or more core networks via a radio access network (RAN). The UE may be an IoT terminal, such as a sensor device, a cell phone (or “cellular” phone), or a computer with an IoT terminal, e.g., a stationary, portable, pocket-sized, handheld, computer built-in, or vehicle-mounted device. For example, the UE may be a station (STA), subscriber unit, subscriber station, mobile station, mobile, remote station, access point, remote terminal, access terminal, user terminal, or user agent. Alternatively, the UE may be a device of an unmanned aerial vehicle. Alternatively, the UE may be a vehicle-mounted device, such as a trip computer with a wireless communication function or a wireless terminal externally connected to a trip computer. Alternatively, the UE may be a road side device, such as a street light, signal light, or other road side devices with a wireless communication function.

In one example of the present disclosure, the ranging service may be triggered by a ranging application service. In another example of the present disclosure, the ranging service may be triggered by a third terminal device other than the first terminal device and a second terminal device, or other application program. In another example of the present disclosure, the ranging service may be triggered by the second terminal device. In another example of the present disclosure, the ranging service may be triggered by the first terminal device itself.

In one example of the present disclosure, the first terminal device may be an observer UE and the second terminal device may be a target UE. In another example of the present disclosure, the first terminal device may be a target UE and the second terminal device may be an observer UE.

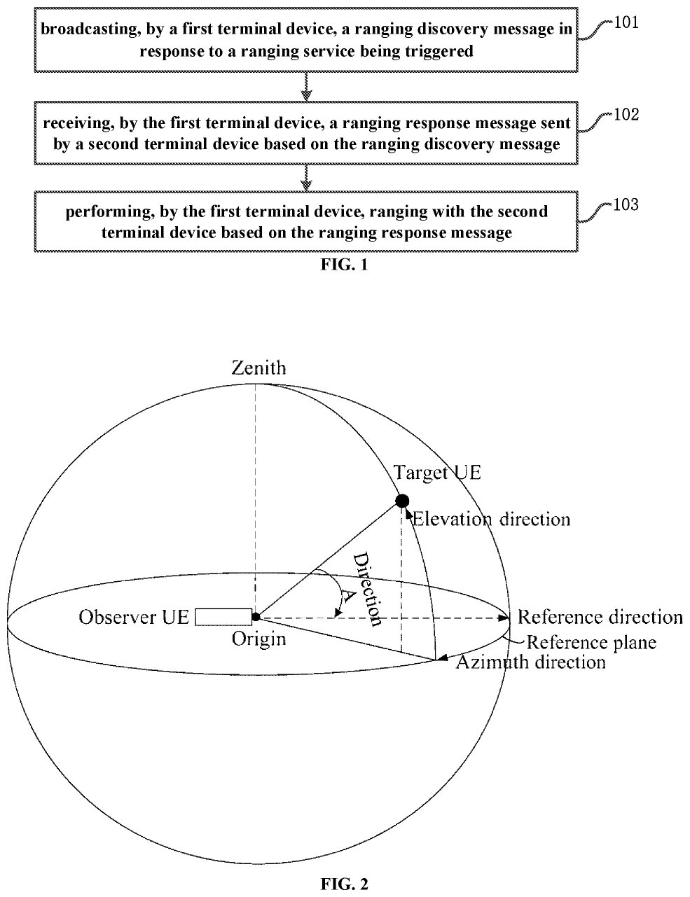

The observer UE may be a UE for performing a ranging operation, and is used for performing ranging on the target UE. As an example, FIG. 2 is a schematic structural diagram of a relative position between an observer UE and a target UE provided by an example of the present disclosure. As shown in FIG. 2, the observer UE is provided with a reference plane and a reference direction. A direction from the target UE to the observer UE may be a direction pointing from a line connecting the observer UE and the target UE to the reference direction, i.e., the direction A shown in FIG. 2. The direction from the target UE to the observer UE may be represented by an azimuth direction and an elevation direction of the target UE. With reference to FIG. 2, the azimuth direction of the target UE is an angel formed by pointing from the reference direction to a projection, on the same plane as the reference direction orthogonal to the zenith, of a line from the observer UE to the target UE. The target UE is also provided with an elevation direction. The elevation direction is a direction pointing from the horizontal plane to a line connecting the observer UE to the target UE.

The observer UE may realize ranging of the target UE by measuring a distance between the target UE and the observer UE and a direction from the target UE to the observer UE, etc., as shown in FIG. 2. Moreover, the ranging service may be performed with or without 5G coverage.

In one example of the present disclosure, the ranging discovery message may include an AOI parameter. For example, the ranging discovery message may include a first ranging service identifier, an identifier of the first terminal device, an area of interest (AOI) parameter, a request identifier, a first line-of-sight transmission capability identifier, and the like. The ranging service identifier may be preset, and the first ranging service identifier may be a ranging service identifier corresponding to the first terminal device.

The AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

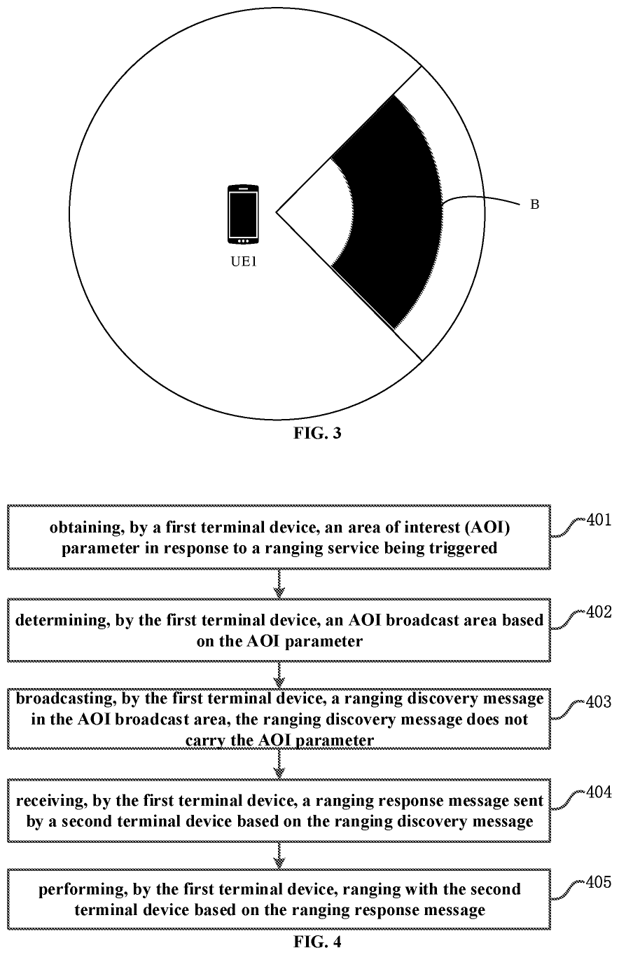

FIG. 3 is a diagram of a position relationship between a first terminal device and its corresponding AOI broadcast area provided by an example of the present disclosure. As shown in FIG. 3, the first terminal device may be, for example, a UE1, whose corresponding AOI broadcast area may be, for example, area B in FIG. 3.

The first line-of-sight transmission capability identifier may be used for indicating that the first terminal device is capable of line-of-sight transmission so that the line-of-sight transmission may be performed subsequently based on the first terminal device. In some examples, the ranging discovery message may not include the AOI parameter. For example, the ranging discovery message may include the first ranging service identifier, the identifier of the first terminal device, the request identifier, and the first line-of-sight transmission capability identifier. In yet another example of the present disclosure, the ranging discovery message may only include the AOI parameter.

At step 102, a ranging response message sent by a second terminal device based on the ranging discovery message is received by the first terminal device. The ranging response message may include a second ranging service identifier. The second ranging service identifier may be a ranging service identifier corresponding to the second terminal device. The ranging discovery message and the ranging response message have a first ranging service identifier.

Of course, in another example of the present disclosure, the ranging response message may include a second ranging service identifier, an identifier of the second terminal device, a request identifier, and a second line-of-sight transmission capability identifier. The second line-of-sight transmission capability identifier may be used for indicating that the second terminal device is capable of line-of-sight transmission so that the line-of-sight transmission may be performed subsequently based on the second terminal device. In another example of the present disclosure, the ranging discovery message may further include an AOI parameter corresponding to the second terminal device.

In yet another example of the present disclosure, the ranging response message may carry an authentication code of the second terminal device to enable the first terminal device to discover the second terminal device based on the authentication code of the second terminal device. In another example of the present disclosure, the ranging response message may carry a matching code to enable the first terminal device to discover the second terminal device based on the matching code.

At step 103, the first terminal device performs ranging with the second terminal device based on the ranging response message. Performing, by the first terminal device, ranging with the second terminal device based on the ranging response message may include: performing, by the first terminal device, ranging with the second terminal device in response to the first ranging service identifier being consistent with the second ranging service identifier.

In one example of the present disclosure, after the first terminal device discovers the second terminal device based on the ranging response message, the first terminal device and the second terminal device may perform accurate ranging based on a quality of service (QOS) requirement. In one example of the present disclosure, the QOS requirement may be sent to the first terminal device by the ranging application server. In another example of the present disclosure, both the first terminal device and the second terminal device are terminal devices with ranging capabilities.

In the ranging method provided in the examples of the present disclosure, the first terminal device broadcasts the ranging discovery message in response to the ranging service being triggered, receives the ranging response message sent by the second terminal device based on the ranging discovery message, and performs ranging with the second terminal device based on the ranging response message. As can be seen, in the examples of the present disclosure, the first terminal device discovers, through broadcasting the ranging discovery message, the second terminal device according to the ranging response message sent by the second terminal device based on the ranging discovery message, and performs ranging with the second terminal device based on the ranging response message. As a result, the first terminal device is able to efficiently discover the second terminal device based on the ranging response message sent by the second terminal device, then the efficiency and accuracy of ranging are improved, the power consumption is reduced, and effective ranging is realized.

FIG. 4 is a flow diagram of a ranging method provided by another example of the present disclosure. The ranging method is applied to a first terminal device. As shown in FIG. 4, the method may include the following steps 401 to 405.

At step 401, an area of interest (AOI) parameter is obtained by a first terminal device in response to a ranging service being triggered. The AOI parameter may be preconfigured in the first terminal device. The AOI parameter can be variable, e.g., may be changed according to user requirements. The AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 402, an AOI broadcast area is determined by the first terminal device based on the AOI parameter. Determining, by the first terminal device, the AOI broadcast area based on the AOI parameter may include: determining, by the first terminal device based on the distance parameter (e.g., a minimum distance and/or a maximum distance), the azimuth parameter (e.g., a minimum azimuth direction and/or a maximum azimuth direction), and the elevation direction parameter (e.g., a minimum elevation direction and/or a maximum elevation direction) included in the AOI parameter, an area conforming to such distance parameter, azimuth parameter, and elevation direction parameter included in the AOI parameter, and determining, by the first terminal device, the area as the AOI broadcast area.

At step 403, a ranging discovery message is broadcast by the first terminal device in the AOI broadcast area, and the ranging discovery message does not carry the AOI parameter. Broadcasting, by the first terminal device, the ranging discovery message in the AOI broadcast area may include: determining, by the first terminal device based on the AOI broadcast area, at least one of a broadcast beam direction or a broadcast power; and broadcasting, by the first terminal device based on the at least one of the broadcast beam direction or the broadcast power, the ranging discovery message.

In one example, when the first terminal device broadcasts the ranging discovery message in the AOI broadcast area, the terminal devices located in the AOI broadcast area are all second terminal devices. The second terminal device may receive the ranging discovery message broadcast by the first terminal device and send a ranging response message to the first terminal device based on the ranging discovery message. In one example of the present disclosure, the second terminal device may be one. In one example of the present disclosure, the second terminal device may be multiple.

At step 404, the first terminal device receives the ranging response message sent by the second terminal device based on the ranging discovery message. The ranging response message may include a second ranging service identifier. The ranging response message may carry an authentication code of the second terminal device to enable the first terminal device to discover the second terminal device based on the authentication code of the second terminal device. In one example of the present disclosure, the ranging response message may carry a matching code to enable the first terminal device to discover the second terminal device based on the matching code. In one example of the present disclosure, the ranging discovery message and the ranging response message include a first ranging service identifier.

At step 405, the first terminal device performs ranging with the second terminal device based on the ranging response message. Performing, by the first terminal device, ranging with the second terminal device based on the ranging response message may include: performing, by the first terminal device, ranging with the second terminal device in response to the first ranging service identifier being consistent with the second ranging service identifier.

In one example of the present disclosure, after the first terminal device discovers the second terminal device based on the ranging response message, the first terminal device and the second terminal device may perform accurate ranging based on a QOS requirement. In one example of the present disclosure, the QOS requirement may be sent to the first terminal device by the ranging application server. Both the first terminal device and the second terminal device may be terminal devices with ranging capabilities.

In the ranging method provided in the examples of the present disclosure, in response to the ranging service being triggered, the first terminal device may determine the AOI broadcast area based on the AOI parameter to broadcast the ranging discovery message only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

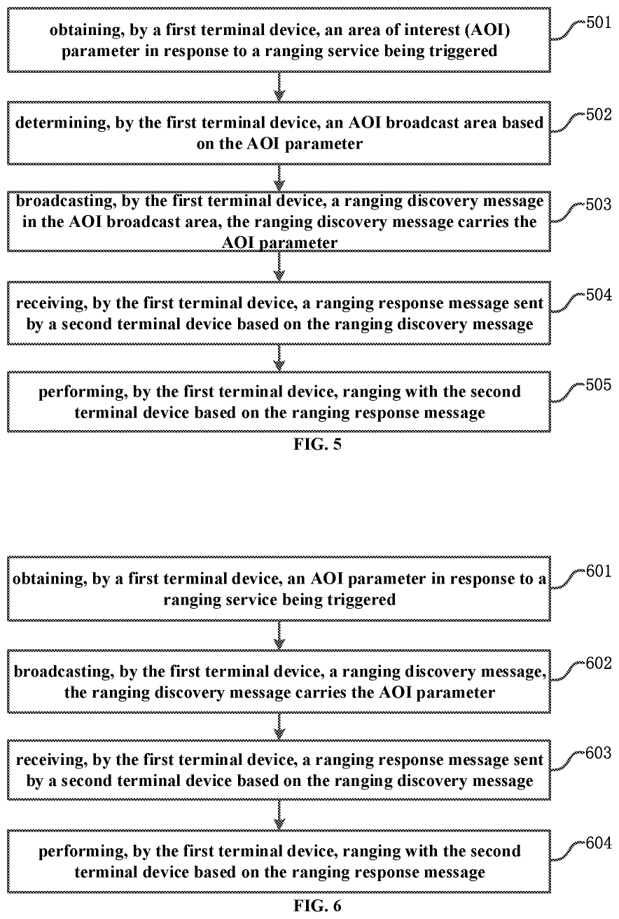

FIG. 5 is a flow diagram of a ranging method provided by yet another example of the present disclosure. The ranging method is applied to a first terminal device. As shown in FIG. 5, the method may include the following steps 501 to 505.

At step 501, an area of interest (AOI) parameter is obtained by a first terminal device in response to a ranging service being triggered. The AOI parameter may be preconfigured in the first terminal device. The AOI parameter can be variable, e.g., may be changed according to user requirements.

In one example of the present disclosure, the AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 502, an AOI broadcast area is determined by the first terminal device based on the AOI parameter. Determining, by the first terminal device, the AOI broadcast area based on the AOI parameter may include: determining, by the first terminal device based on the distance parameter (e.g., a minimum distance and/or a maximum distance), the azimuth parameter (e.g., a minimum azimuth direction and/or a maximum azimuth direction), and the elevation direction parameter (e.g., a minimum elevation direction and/or a maximum elevation direction) included in the AOI parameter, an area conforming to such distance parameter, azimuth parameter, and elevation direction parameter included in the AOI parameter, and determining, by the first terminal device, the area as the AOI broadcast area.

At step 503, a ranging discovery message is broadcast by the first terminal device in the AOI broadcast area, and the ranging discovery message carries the AOI parameter. Broadcasting, by the first terminal device, the ranging discovery message in the AOI broadcast area may include: determining, by the first terminal device based on the AOI broadcast area, at least one of a broadcast beam direction or a broadcast power; and broadcasting, by the first terminal device based on the at least one of the broadcast beam direction or the broadcast power, the ranging discovery message.

In one example, terminal devices located in the AOI broadcast area are all second terminal devices when the first terminal device broadcasts the ranging discovery message in the AOI broadcast area. The second terminal device may receive the ranging discovery message broadcast by the first terminal device and send a ranging response message to the first terminal device based on the ranging discovery message. In one example of the present disclosure, the second terminal device may be one. In one example of the present disclosure, the second terminal device may be multiple.

At step 504, the first terminal device receives the ranging response message sent by the second terminal device based on the ranging discovery message. The ranging response message may include a second ranging service identifier. The ranging response message may carry an authentication code of the second terminal device to enable the first terminal device to discover the second terminal device based on the authentication code of the second terminal device. The ranging response message may carry a matching code to enable the first terminal device to discover the second terminal device based on the matching code. In one example of the present disclosure, the ranging discovery message and the ranging response message include a first ranging service identifier.

At step 505, the first terminal device performs ranging with the second terminal device based on the ranging response message. Performing, by the first terminal device, ranging with the second terminal device based on the ranging response message may include: performing, by the first terminal device, ranging with the second terminal device in response to the first ranging service identifier being consistent with the second ranging service identifier.

In one example of the present disclosure, after the first terminal device discovers the second terminal device based on the ranging response message, the first terminal device and the second terminal device may perform accurate ranging based on a QOS requirement. In one example of the present disclosure, the QOS requirement may be sent to the first terminal device by the ranging application server. In one example of the present disclosure, both the first terminal device and the second terminal device are terminal devices with ranging capabilities.

In the ranging method provided in the examples of the present disclosure, in response to the ranging service being triggered, the first terminal device may determine the AOI broadcast area based on the AOI parameter to broadcast the ranging discovery message only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

FIG. 6 is a flow diagram of a ranging method provided by yet another example of the present disclosure. The ranging method is applied to a first terminal device. As shown in FIG. 6, the method may include the following steps 601 to 604.

At step 601, an AOI parameter is obtained by a first terminal device in response to a ranging service being triggered. The AOI parameter may be preconfigured in the first terminal device. In one example of the present disclosure, the AOI parameter is variable, e.g., may be changed according to user requirements.

In one example of the present disclosure, the AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 602, a ranging discovery message is broadcast by the first terminal device, and the ranging discovery message carries the AOI parameter. Broadcasting, by the first terminal device, the ranging discovery message in the AOI broadcast area may include: determining, by the first terminal device based on the AOI broadcast area, at least one of a broadcast beam direction or a broadcast power; and broadcasting, by the first terminal device based on the at least one of the broadcast beam direction or the broadcast power, the ranging discovery message.

In one example of the present disclosure, after the first terminal device broadcasts the ranging discovery message, the second terminal device that obtains the ranging discovery message may determine, based on the AOI parameter carried in the ranging discovery message, whether the second terminal device conforms to the AOI parameter (e.g., the second terminal device may determine whether it is in the AOI broadcast area indicated by the AOI parameter). If the second terminal device determines, based on the AOI parameter, that the second terminal device conforms to the AOI parameter (e.g., the second terminal device determines that it is in the AOI broadcast area indicated by the AOI parameter), the second terminal device may send the ranging response message to the first terminal device. If the second terminal device determines that the second terminal device does not conform to the AOI parameter (e.g., the second terminal device determines that it is not in the AOI broadcast area indicated by the AOI parameter), the second terminal device may not send the ranging response message.

At step 603, the first terminal device receives the ranging response message sent by the second terminal device based on the ranging discovery message. The ranging response message may include a second ranging service identifier. The ranging response message may carry an authentication code of the second terminal device to enable the first terminal device to discover the second terminal device based on the authentication code of the second terminal device.

In one example of the present disclosure, the ranging response message may carry a matching code to enable the first terminal device to discover the second terminal device based on the matching code. The ranging discovery message and the ranging response message may include a first ranging service identifier.

At step 604, the first terminal device performs ranging with the second terminal device based on the ranging response message. Performing, by the first terminal device, ranging with the second terminal device based on the ranging response message may include: performing, by the first terminal device, ranging with the second terminal device in response to the first ranging service identifier being consistent with the second ranging service identifier.

The first terminal device specifically performs ranging with the second terminal device that has sent the ranging response message. In one example of the present disclosure, the second terminal device that has sent the ranging response message may be one. In one example of the present disclosure, the second terminal device that has sent the ranging response message may be multiple.

In one example of the present disclosure, after the first terminal device discovers, based on the ranging response message, the second terminal device that has sent the ranging response message, the first terminal device and the second terminal device may perform accurate ranging based on a QOS requirement. In one example of the present disclosure, the QOS requirement may be sent to the first terminal device by the ranging application server. In one example of the present disclosure, both the first terminal device and the second terminal device are terminal devices with ranging capabilities.

In the ranging methods provided in examples of the present disclosure, a first terminal device broadcasts, in response to a ranging service being triggered, a ranging discovery message carrying an AOI parameter to discover a second terminal device based on a ranging response message sent by the second terminal device according to the ranging discovery message, and the second terminal device may send, in a case of determining that it conforms to the AOI parameter, the ranging response message to the first terminal device. As a result, in the examples of the present disclosure, the first terminal device, after broadcasting the ranging discovery message carrying the AOI parameter, may not receive ranging response messages sent by all the terminal devices, but may only receive the ranging response message sent by the second terminal device that conforms to the AOI parameter, so as to discover the second terminal device. This can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

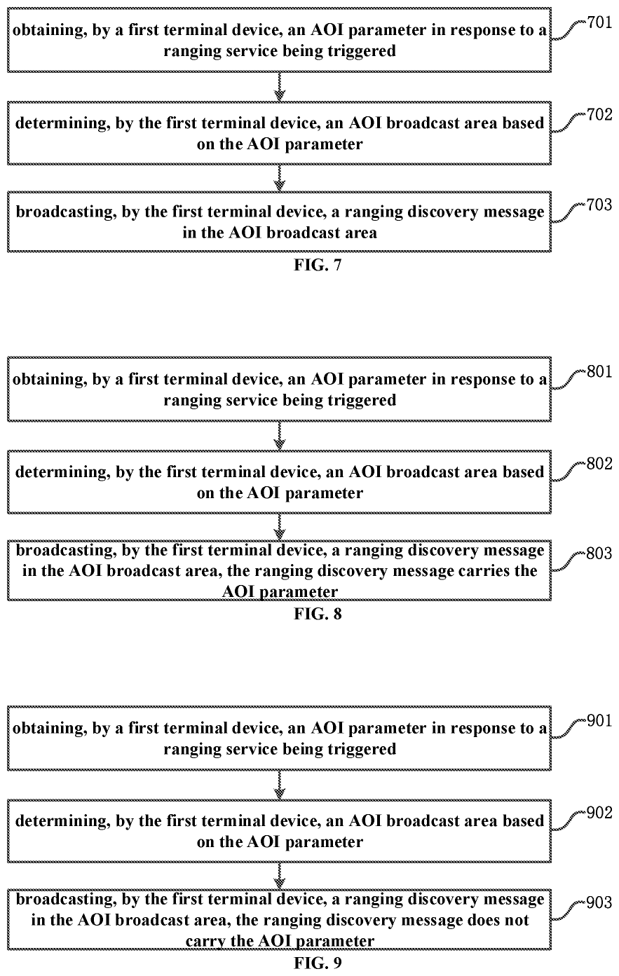

FIG. 7 is a flow diagram of a ranging method provided by yet another example of the present disclosure. The ranging method is applied to a first terminal device. As shown in FIG. 7, the method may include the following steps 701 to 703.

At step 701, an AOI parameter is obtained by a first terminal device in response to a ranging service being triggered. The AOI parameter may be preconfigured in the first terminal device. In one example of the present disclosure, the AOI parameter is variable, e.g., may be changed according to user requirements. The AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 702, an AOI broadcast area is determined by the first terminal device based on the AOI parameter. Determining, by the first terminal device, the AOI broadcast area based on the AOI parameter may include: determining, by the first terminal device based on the distance parameter (e.g., a minimum distance and/or a maximum distance), the azimuth parameter (e.g., a minimum azimuth direction and/or a maximum azimuth direction), and the elevation direction parameter (e.g., a minimum elevation direction and/or a maximum elevation direction) included in the AOI parameter, an area conforming to such distance parameter, azimuth parameter, and elevation direction parameter included in the AOI parameter, and determining, by the first terminal device, the area as the AOI broadcast area.

At step 703, a ranging discovery message is broadcast by the first terminal device in the AOI broadcast area. Broadcasting, by the first terminal device, the ranging discovery message in the AOI broadcast area may include: determining, by the first terminal device based on the AOI broadcast area, at least one of a broadcast beam direction or a broadcast power; and broadcasting, by the first terminal device based on the at least one of the broadcast beam direction or the broadcast power, the ranging discovery message.

In one example, when the first terminal device broadcasts the ranging discovery message in the AOI broadcast area, the terminal devices located in the AOI broadcast area are all second terminal devices. The second terminal device may receive the ranging discovery message broadcast by the first terminal device and send a ranging response message to the first terminal device based on the ranging discovery message.

In one example of the present disclosure, the second terminal device may be one. In one example of the present disclosure, the second terminal device may be multiple. In one example of the present disclosure, the ranging discovery message may carry the AOI parameter. In another example of the present disclosure, the ranging discovery message may not carry the AOI parameter.

In the ranging method provided in the examples of the present disclosure, in response to the ranging service being triggered, the first terminal device may determine the AOI broadcast area based on the AOI parameter to broadcast the ranging discovery message only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

FIG. 8 is a flow diagram of a ranging method provided by yet another example of the present disclosure. The ranging method is applied to a first terminal device. As shown in FIG. 8, the method may include the following steps 801 to 803.

At step 801, an AOI parameter is obtained by a first terminal device in response to a ranging service being triggered. The AOI parameter may be preconfigured in the first terminal device. In one example of the present disclosure, the AOI parameter is variable, e.g., may be changed according to user requirements. The AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 802, an AOI broadcast area is determined by the first terminal device based on the AOI parameter.

In one example of the present disclosure, the method of determining, by the first terminal device, the AOI broadcast area based on the AOI parameter may include: determining, by the first terminal device based on the distance parameter (e.g., a minimum distance and/or a maximum distance), the azimuth parameter (e.g., a minimum azimuth direction and/or a maximum azimuth direction), and the elevation direction parameter (e.g., a minimum elevation direction and/or a maximum elevation direction) included in the AOI parameter, an area conforming to such distance parameter, azimuth parameter, and elevation direction parameter included in the AOI parameter, and determining, by the first terminal device, the area as the AOI broadcast area.

At step 803, a ranging discovery message is broadcast by the first terminal device in the AOI broadcast area, and the ranging discovery message carries the AOI parameter. Broadcasting, by the first terminal device, the ranging discovery message in the AOI broadcast area may include: determining, by the first terminal device based on the AOI broadcast area, at least one of a broadcast beam direction or a broadcast power; and broadcasting, by the first terminal device based on the at least one of the broadcast beam direction or the broadcast power, the ranging discovery message.

In one example, when the first terminal device broadcasts the ranging discovery message in the AOI broadcast area, terminal devices located in the AOI broadcast area are all second terminal devices. The second terminal device may receive the ranging discovery message broadcast by the first terminal device and send a ranging response message to the first terminal device based on the ranging discovery message. In one example of the present disclosure, the second terminal device may be one. In one example of the present disclosure, the second terminal device may be multiple.

In the ranging method provided in the examples of the present disclosure, in response to the ranging service being triggered, the first terminal device may determine the AOI broadcast area based on the AOI parameter to broadcast the ranging discovery message only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

FIG. 9 is a flow diagram of a ranging method provided by yet another example of the present disclosure. The ranging method is applied to a first terminal device. As shown in FIG. 9, the method may include the following steps 901 to 903.

At step 901, an AOI parameter is obtained by a first terminal device in response to a ranging service being triggered. The AOI parameter may be preconfigured in the first terminal device. In one example of the present disclosure, the AOI parameter is variable, e.g., may be changed according to user requirements. The AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 902, an AOI broadcast area is determined by the first terminal device based on the AOI parameter. Determining, by the first terminal device, the AOI broadcast area based on the AOI parameter may include: determining, by the first terminal device based on the distance parameter (e.g., a minimum distance and/or a maximum distance), the azimuth parameter (e.g., a minimum azimuth direction and/or a maximum azimuth direction), and the elevation direction parameter (e.g., a minimum elevation direction and/or a maximum elevation direction) included in the AOI parameter, an area conforming to such distance parameter, azimuth parameter, and elevation direction parameter included in the AOI parameter, and determining, by the first terminal device, the area as the AOI broadcast area.

At step 903, a ranging discovery message is broadcast by the first terminal device in the AOI broadcast area, and the ranging discovery message does not carry the AOI parameter. Broadcasting, by the first terminal device, the ranging discovery message in the AOI broadcast area may include: determining, by the first terminal device based on the AOI broadcast area, at least one of a broadcast beam direction or a broadcast power; and broadcasting, by the first terminal device based on the at least one of the broadcast beam direction or the broadcast power, the ranging discovery message.

In one example, when the first terminal device broadcasts the ranging discovery message in the AOI broadcast area, terminal devices located in the AOI broadcast area are all second terminal devices. The second terminal device may receive the ranging discovery message broadcast by the first terminal device and send a ranging response message to the first terminal device based on the ranging discovery message. In one example of the present disclosure, the second terminal device may be one. In one example of the present disclosure, the second terminal device may be multiple.

In the ranging method provided in the examples of the present disclosure, in response to the ranging service being triggered, the first terminal device may determine the AOI broadcast area based on the AOI parameter to broadcast the ranging discovery message only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

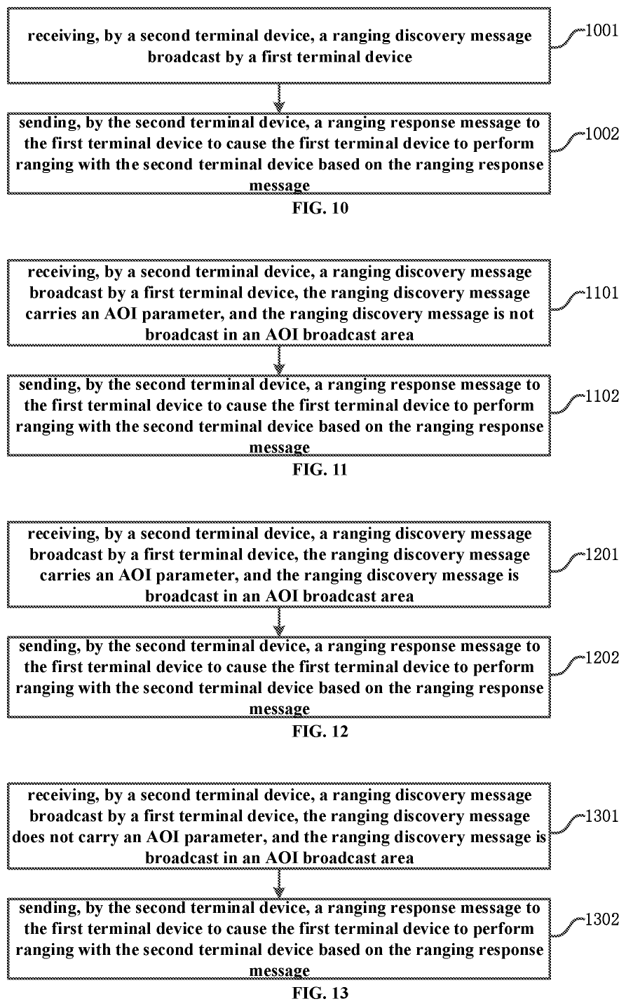

FIG. 10 is a flow diagram of a ranging method provided by yet another example of the present disclosure. The ranging method is applied to a second terminal device. As shown in FIG. 10, the method may include the following steps 1001 to 1002.

At step 1001, a ranging discovery message broadcast by a first terminal device is received by a second terminal device. The ranging discovery message may include an AOI parameter. For example, the ranging discovery message may include a first ranging service identifier, an identifier of the first terminal device, an AOI parameter, a request identifier, a first line-of-sight transmission capability identifier, and the like. Of course, in another example of the present disclosure, the ranging discovery message may not include the AOI parameter. For example, the ranging discovery message may include the first ranging service identifier, the identifier of the first terminal device, the request identifier, and the first line-of-sight transmission capability identifier. In yet another example of the present disclosure, the ranging discovery message may only include the AOI parameter.

In an example of the present disclosure, the AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 1002, a ranging response message is sent by the second terminal device to the first terminal device to cause the first terminal device to perform ranging with the second terminal device based on the ranging response message. The ranging response message may include a second ranging service identifier. The ranging response message may carry an authentication code of the second terminal device to enable the first terminal device to discover the second terminal device based on the authentication code of the second terminal device. The ranging response message may carry a matching code to enable the first terminal device to discover the second terminal device based on the matching code. The ranging discovery message and the ranging response message may include a first ranging service identifier.

In one example of the present disclosure, the method of sending, by the second terminal device, the ranging response message to the first terminal device may include: determining, by the second terminal device based on the AOI parameter carried in the ranging discovery message, whether the second terminal device conforms to the AOI parameter (e.g., the second terminal device may determine whether it is in the AOI broadcast area indicated by the AOI parameter). If the second terminal device determines, based on the AOI parameter, that the second terminal device conforms to the AOI parameter (e.g., the second terminal device determines that it is in the AOI broadcast area indicated by the AOI parameter), the second terminal device may send the ranging response message to the first terminal device. If the second terminal device determines that the second terminal device does not conform to the AOI parameter (e.g., the second terminal device determines that it is not in the AOI broadcast area indicated by the AOI parameter), the second terminal device may not send the ranging response message.

In the ranging method provided in the examples of the present disclosure, the second terminal device, after receiving the ranging discovery message broadcast by the first terminal device, may send the ranging response message to the first terminal device to cause the first terminal device to perform ranging with the second terminal device based on the ranging response message. As can be seen, in the examples of the present disclosure, the first terminal device discovers, through broadcasting the ranging discovery message, the second terminal device according to the ranging response message sent by the second terminal device based on the ranging discovery message, and performs ranging with the second terminal device based on the ranging response message. As a result, the first terminal device is able to efficiently discover the second terminal device based on the ranging response message sent by the second terminal device, then the efficiency and accuracy of ranging are improved, the power consumption is reduced, and effective ranging is realized.

FIG. 11 is a flow diagram of a ranging method provided by yet another example of the present disclosure. The ranging method is applied to a second terminal device. As shown in FIG. 11, the method may include the following steps 1101 to 1102.

At step 1101, a ranging discovery message broadcast by a first terminal device is received by the second terminal device, the ranging discovery message carries an AOI parameter, and the ranging discovery message is not broadcast in an AOI broadcast area. The AOI parameter may be used for indicating the AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area). In one example of the present disclosure, the fact that the ranging discovery message is not broadcast in the AOI broadcast area may indicate that the ranging discovery message is directly broadcast by the first terminal device.

At step 1102, a ranging response message is sent by the second terminal device to the first terminal device to cause the first terminal device to perform ranging with the second terminal device based on the ranging response message. The ranging response message may include a second ranging service identifier. In another example of the present disclosure, the ranging response message may carry an authentication code of the second terminal device to enable the first terminal device to discover the second terminal device based on the authentication code of the second terminal device. The ranging response message may carry a matching code to enable the first terminal device to discover the second terminal device based on the matching code. The ranging discovery message and the ranging response message may include a first ranging service identifier.

In one example of the present disclosure, the method of sending, by the second terminal device, the ranging response message to the first terminal device may include: determining, by the second terminal device based on the AOI parameter carried in the ranging discovery message, whether the second terminal device conforms to the AOI parameter (e.g., the second terminal device may determine whether it is in the AOI broadcast area indicated by the AOI parameter). If the second terminal device determines, based on the AOI parameter, that the second terminal device conforms to the AOI parameter (e.g., the second terminal device determines that it is in the AOI broadcast area indicated by the AOI parameter), the second terminal device may send the ranging response message to the first terminal device. If the second terminal device determines that the second terminal device does not conform to the AOI parameter (e.g., the second terminal device determines that it is not in the AOI broadcast area indicated by the AOI parameter), the second terminal device may not send the ranging response message.

In the ranging method provided in the examples of the present disclosure, the second terminal device, after receiving the ranging discovery message including the AOI parameter, may determine whether the second terminal device conforms to the AOI parameter, and may send the ranging response message to the first terminal device in a case of the second terminal device conforming to the AOI parameter. As a result, in the examples of the present disclosure, the first terminal device, after broadcasting the ranging discovery message carrying the AOI parameter, may not receive ranging response messages sent by all the terminal devices, but may only receive the ranging response message sent by the second terminal device that conforms to the AOI parameter, so as to discover the second terminal device. This can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

FIG. 12 is a flow diagram of a ranging method provided by yet another example of the present disclosure. The ranging method is applied to a second terminal device. As shown in FIG. 12, the method may include the following steps 1201 to 1202.

At step 1201, a ranging discovery message broadcast by a first terminal device is received by a second terminal device, the ranging discovery message carries an AOI parameter, and the ranging discovery message is broadcast in an AOI broadcast area. The AOI parameter may be used for indicating an AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 1202, a ranging response message is sent by the second terminal device to the first terminal device to cause the first terminal device to perform ranging with the second terminal device based on the ranging response message. The ranging response message may include a second ranging service identifier. The ranging response message may carry an authentication code of the second terminal device to enable the first terminal device to discover the second terminal device based on the authentication code of the second terminal device. The ranging response message may carry a matching code to enable the first terminal device to discover the second terminal device based on the matching code. The ranging discovery message and the ranging response message may include a first ranging service identifier.

In one example of the present disclosure, the method of sending, by the second terminal device, the ranging response message to the first terminal device may include: determining, by the second terminal device based on the AOI parameter carried in the ranging discovery message, whether the second terminal device conforms to the AOI parameter (e.g., the second terminal device may determine whether it is in the AOI broadcast area indicated by the AOI parameter). If the second terminal device determines, based on the AOI parameter, that the second terminal device conforms to the AOI parameter (e.g., the second terminal device determines that it is in the AOI broadcast area indicated by the AOI parameter), the second terminal device may send the ranging response message to the first terminal device. If the second terminal device determines that the second terminal device does not conform to the AOI parameter (e.g., the second terminal device determines that it is not in the AOI broadcast area indicated by the AOI parameter), the second terminal device may not send the ranging response message.

In the ranging method provided in the examples of the present disclosure, the first terminal device may cause, based on the AOI parameter, the ranging discovery message to be broadcast only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

FIG. 13 is a flow diagram of a ranging method provided by yet another example of the present disclosure. The ranging method is applied to a second terminal device. As shown in FIG. 13, the method may include the following steps 1301 to 1302.

At step 1301, a ranging discovery message broadcast by a first terminal device is received by a second terminal device, the ranging discovery message does not carry an AOI parameter, and the ranging discovery message is broadcast in an AOI broadcast area. The AOI parameter may be used for indicating the AOI broadcast area (i.e., an area of concern or an area of interest of the first terminal device) corresponding to the first terminal device. The AOI parameter may include one or more of a distance parameter (e.g., a minimum distance and/or a maximum distance between the first terminal device and its corresponding AOI area), an azimuth parameter (e.g., a minimum azimuth direction and/or a maximum azimuth direction between the first terminal device and its corresponding AOI area) or an elevation direction parameter (e.g., a minimum elevation direction and/or a maximum elevation direction between the first terminal device and its corresponding AOI area).

At step 1302, a ranging response message is sent by the second terminal device to the first terminal device to cause the first terminal device to perform ranging with the second terminal device based on the ranging response message. The ranging discovery message may include a first ranging service identifier, and the ranging response message may include a second ranging service identifier. The ranging response message may carry an authentication code of the second terminal device to enable the first terminal device to discover the second terminal device based on the authentication code of the second terminal device. The ranging response message may carry a matching code to enable the first terminal device to discover the second terminal device based on the matching code. The ranging discovery message and the ranging response message may include a first ranging service identifier.

In one example of the present disclosure, the method of sending, by the second terminal device, the ranging response message to the first terminal device may include: determining, by the second terminal device based on the AOI parameter carried in the ranging discovery message, whether the second terminal device conforms to the AOI parameter (e.g., the second terminal device may determine whether it is in the AOI broadcast area indicated by the AOI parameter). If the second terminal device determines, based on the AOI parameter, that the second terminal device conforms to the AOI parameter (e.g., the second terminal device determines that it is in the AOI broadcast area indicated by the AOI parameter), the second terminal device may send the ranging response message to the first terminal device. If the second terminal device determines that the second terminal device does not conform to the AOI parameter (e.g., the second terminal device determines that it is not in the AOI broadcast area indicated by the AOI parameter), the second terminal device may not send the ranging response message.

In the ranging method provided in the examples of the present disclosure, the first terminal device may cause, based on the AOI parameter, the ranging discovery message to be broadcast only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

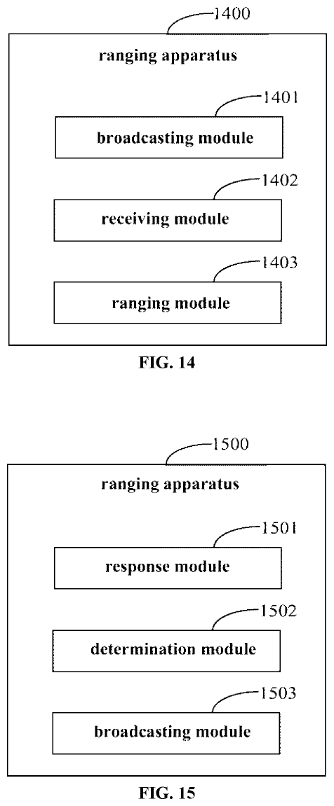

FIG. 14 is a schematic structural diagram of a ranging apparatus 1400 provided by an example of the present disclosure. The ranging apparatus 1400 is applied to a first terminal device. As shown in FIG. 14, the ranging apparatus 1400 may include: a broadcasting module 1401, configured to broadcast a ranging discovery message in response to a ranging service being triggered; a receiving module 1402, configured to receive a ranging response message sent by a second terminal device based on the ranging discovery message; and a ranging module 1403, configured to perform ranging with the second terminal device based on the ranging response message.

In the ranging apparatus provided in the examples of the present disclosure, the first terminal device may broadcast, by using the ranging apparatus, the ranging discovery message in response to the ranging service being triggered, receive the ranging response message sent by the second terminal device based on the ranging discovery message, and perform ranging with the second terminal device based on the ranging response message. As can be seen, in the examples of the present disclosure, the first terminal device discovers, through broadcasting the ranging discovery message, the second terminal device according to the ranging response message sent by the second terminal device based on the ranging discovery message, and performs ranging with the second terminal device based on the ranging response message. As a result, the first terminal device is able to efficiently discover the second terminal device based on the ranging response message sent by the second terminal device, then the efficiency and accuracy of ranging are improved, the power consumption is reduced, and effective ranging is realized.

In one example, the ranging discovery message may include a first ranging service identifier, and the ranging response message may include a second ranging service identifier. The performing, by the first terminal device, ranging with the second terminal device based on the ranging response message includes: performing, by the first terminal device, ranging with the second terminal device in response to the first ranging service identifier being consistent with the second ranging service identifier.

In one example of the present disclosure, the broadcasting module 1401 is specifically configured to: obtain an area of interest (AOI) parameter, determine an AOI broadcast area based on the AOI parameter, and broadcast the ranging discovery message in the AOI broadcast area. The broadcasting module 1401 may be specifically configured to: determine, based on the AOI broadcast area, at least one of a broadcast beam direction or a broadcast power, and broadcast, based on the at least one of the broadcast beam direction or the broadcast power, the ranging discovery message.

Furthermore, in another example of the present disclosure, the ranging discovery message carries the AOI parameter. The broadcasting module 1401 may be specifically configured to: obtain an AOI parameter, and broadcast the ranging discovery message including the AOI parameter. The ranging response message may include an identifier of the second terminal device. The AOI parameter may include one or more of a distance parameter, an azimuth parameter, or an elevation direction parameter. The ranging discovery message and the ranging response message may further include a line-of-sight transmission capability identifier.

FIG. 15 is a schematic structural diagram of a ranging apparatus 1500 provided by another example of the present disclosure. The ranging apparatus 1500 is applied to a first terminal device. As shown in FIG. 15, the ranging apparatus 1500 may include: a response module 1501, configured to obtain an AOI parameter in response to a ranging service being triggered; a determination module 1502, configured to determine an AOI broadcast area based on the AOI parameter; and a broadcasting module 1503, configured to broadcast a ranging discovery message in the AOI broadcast area.

In the ranging apparatus applied to the first terminal device provided in the examples of the present disclosure, in response to the ranging service being triggered, the first terminal device may determine, by using the ranging apparatus, the AOI broadcast area based on the AOI parameter to broadcast the ranging discovery message only to the AOI broadcast area. As a result, in the examples of the present disclosure, the first terminal device may discover, through directional broadcasting of the ranging discovery message based on the AOI parameter, the second terminal device, in order to perform ranging with the second terminal device. The first terminal device may only discover the second terminal device located in the AOI broadcast area, which can avoid the first terminal device from discovering terminal devices that do not have ranging capabilities or terminal devices of no interest, ensuring that the first terminal device is able to efficiently discover the second terminal device, then the efficiency and accuracy of ranging are improved, the power consumption is reduced, and effective ranging is realized.

In one example of the present disclosure, the broadcasting module 1503 is specifically configured to: determine, based on the AOI broadcast area, at least one of a broadcast beam direction or a broadcast power, and broadcast, based on the at least one of the broadcast beam direction or the broadcast power, the ranging discovery message. The ranging discovery message may carry the AOI parameter. The AOI parameter may include one or more of a distance parameter, an azimuth parameter, or an elevation direction parameter.

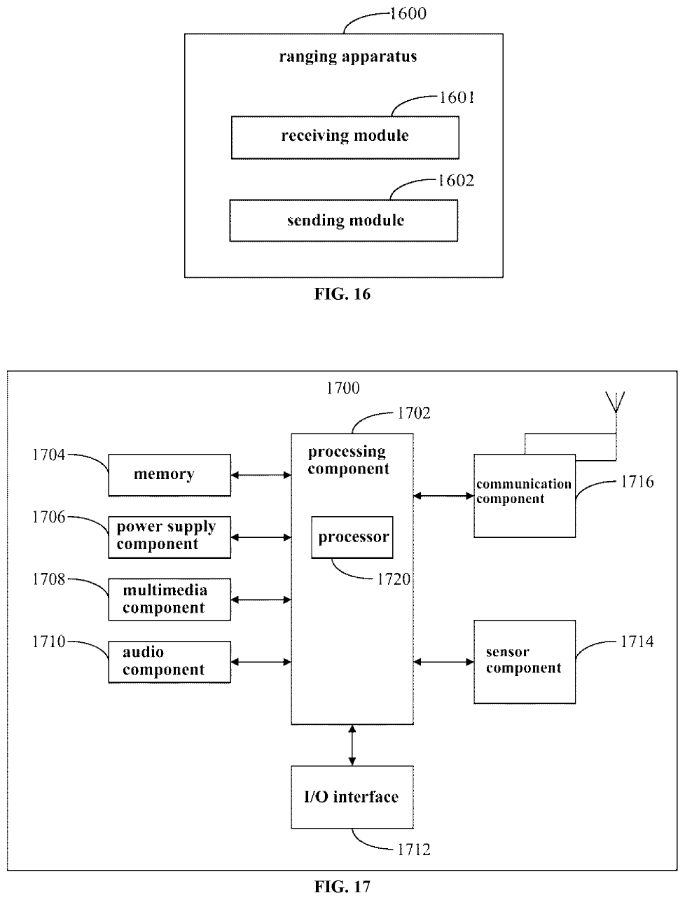

FIG. 16 is a schematic structural diagram of a ranging apparatus 1600 provided by yet another example of the present disclosure. The ranging apparatus 1600 is applied to a second terminal device. As shown in FIG. 16, the ranging apparatus 1600 may include: a receiving module 1601, configured to receive a ranging discovery message broadcast by a first terminal device; and a sending module 1602, configured to send a ranging response message to the first terminal device.

In the ranging apparatus applied to the second terminal device provided in the examples of the present disclosure, the second terminal device, after receiving through the ranging apparatus the ranging discovery message broadcast by the first terminal device, may send the ranging response message to the first terminal device to cause the first terminal device to perform ranging with the second terminal device based on the ranging response message. As can be seen, in the examples of the present disclosure, the first terminal device discovers, through broadcasting the ranging discovery message, the second terminal device according to the ranging response message sent by the second terminal device based on the ranging discovery message, and performs ranging with the second terminal device based on the ranging response message. As a result, the first terminal device is able to efficiently discover the second terminal device based on the ranging response message sent by the second terminal device, then the efficiency and accuracy of ranging are improved, the power consumption is reduced, and effective ranging is realized.

The ranging discovery message and the ranging response message may include a first ranging service identifier. The ranging discovery message and the ranging response message can further include a line-of-sight transmission capability identifier. In one example of the present disclosure, the ranging discovery message is broadcast in an AOI broadcast area. The ranging discovery message may further include an AOI parameter.

In one example, the sending module 1602 is specifically configured to: determine, based on the AOI parameter, whether the second terminal device conforms to the AOI parameter; send the ranging response message to the first terminal device in response to the second terminal device conforming to the AOI parameter; and not send the ranging response message in response to the second terminal device not conforming to the AOI parameter. The AOI parameter can include one or more of a distance parameter, an azimuth parameter, or an elevation direction parameter.

In order to implement the above examples, the present disclosure also proposes a computer storage medium. The computer storage medium provided by the examples of the present disclosure stores an executable program. The executable program, when executed by a processor, is capable of implementing the ranging method provided by any of the foregoing technical solutions, for example, at least one of FIGS. 1 and 4 to 13.

Additionally, in order to implement the above examples, the present disclosure also proposes a computer program. The computer program, when executed by a processor, implements the ranging method as described in FIGS. 1 and 4 to 13 of the present disclosure.

FIG. 17 is a block diagram of a user equipment (UE) 1700 provided by an example of the present disclosure. For example, the UE 1700 may be a cell phone, a computer, a digital broadcasting terminal device, a message transceiver device, a gaming console, a tablet device, a medical device, a fitness device, a personal digital assistant, and the like.

Referring to FIG. 17, the UE 1700 may include at least one of the following components: a processing component 1702, a memory 1704, a power supply component 1706, a multimedia component 1708, an audio component 1710, an input/output (I/O) interface 1712, a sensor component 1714, and a communication component 1716.

The processing component 1702 generally controls the overall operation of the UE 1700, such as operations associated with display, telephone calls, data communication, camera operations, and recording operations. The processing component 1702 may include one or more processors 1720 to execute an instruction to complete all or some of the steps of the methods described above. In addition, the processing component 1702 may include at least one module that facilitates interaction between the processing component 1702 and other components. For example, the processing component 1702 may include a multimedia module to facilitate interaction between the multimedia component 1708 and the processing component 1702.

The memory 1704 is configured to store various types of data to support the operations at the UE 1700. Examples of such data include the following for any application or method to operate on the UE 1700: instructions, contact data, phonebook data, messages, pictures, videos, etc. The memory 1704 may be implemented by any type of volatile or non-volatile storage device or a combination thereof, such as a static random access memory (SRAM), electrically erasable programmable read-only memory (EEPROM), erasable programmable read-only memory (EPROM), programmable read-only memory (PROM), read-only memory (ROM), magnetic memory, flash memory, disk or CD-ROM.

The power supply component 1706 supplies power to various components of the UE 1700. The power supply component 1706 may include a power supply management system, at least one power supply, and other components associated with generating, managing, and distributing power for the UE 1700.

The multimedia component 1708 includes a screen that provides an output interface between the UE 1700 and a user. In some examples, the screen may include a liquid crystal display (LCD) and a touch panel (TP). If the screen includes a touch panel, the screen may be implemented as a touch screen to receive input signals from the user. The touch panel includes at least one touch sensor to sense touches, swipes, and gestures on the touch panel. The touch sensor may not only sense the boundaries of the touch or swipe action, but also detect the wake-up time and pressure associated with the touch or swipe action. In some examples, the multimedia component 1708 includes a front-facing camera and/or a rear-facing camera. The front-facing camera and/or the rear-facing camera may receive external multimedia data when the UE 1700 is in an operating mode, such as a shooting mode or a video mode. Each of the front-facing camera and the rear-facing camera may be a fixed optical lens system or have a focal length and optical zoom capability.

The audio component 1710 is configured to output and/or input audio signals. For example, the audio component 1710 includes a microphone (MIC), configured to receive external audio signals when the UE 1700 is in an operating mode, such as a call mode, a recording mode, and a voice recognition mode. The received audio signals may be further stored in the memory 1704 or sent via the communication component 1716. In some examples, the audio component 1710 further includes a speaker for outputting the audio signals.

The I/O interface 1712 provides an interface between the processing component 1702 and a peripheral interface module, and the peripheral interface module may be a keypad, a click wheel, a button, etc. These buttons may include, but are not limited to, a home button, a volume button, a start button, and a lock button.

The sensor component 1714 includes at least one sensor, used for providing a status assessment of various aspects of the UE 1700. For example, the sensor component 1714 may detect an open/closed state of the UE 1700, relative positioning of the components, for example, the components are the display and keypad of the UE 1700, the sensor component 1714 may also detect a change in the position of the UE 1700 or a change in the position of one component of the UE 1700, the presence or absence of user contact with the UE 1700, the orientation or acceleration/deceleration of the UE 1700, and temperature changes of the UE 1700. The sensor component 1714 may include a proximity sensor, configured to detect the presence of nearby objects in the absence of any physical contact. The sensor component 1714 may also include a light sensor, such as a CMOS or CCD image sensor, for use in imaging applications. In some examples, the sensor component 1714 may also include an accelerometer sensor, a gyroscope sensor, a magnetic sensor, a pressure sensor, or a temperature sensor.

The communication component 1716 is configured to facilitate the communication between the UE 1700 and other devices by wired or wireless means. The UE 1700 may access a wireless network based on a communication standard, such as Wi-Fi, 2G, 3G or a combination thereof. In one example, the communication component 1716 receives broadcast signals or broadcast-related information from an external broadcast management system via a broadcast channel. In an example, the communication component 1716 further includes a near-field communication (NFC) module to facilitate short-range communication. For example, the NFC module may be implemented based on radio frequency identification (RFID) technology, infrared data association (IrDA) technology, ultra-wideband (UWB) technology, bluetooth (BT) technology, and the like.

In one example, the UE 1700 may be implemented by at least one application-specific integrated circuit (ASIC), digital signal processor (DSP), digital signal processing device (DSPD), programmable logic device (PLD), field-programmable gate array (FPGA), controller, microcontroller, microprocessor, or other electronic element, and configured to perform the above methods.

In one example, a non-transitory computer-readable storage medium including an instruction is provided, such as a memory 1704 including an instruction. The instruction described above is capable of being executed by the processor 1720 of the UE 1700 to complete the above methods. For example, the non-transitory computer-readable storage medium may be a ROM, a random access memory (RAM), a CD-ROM, a magnetic tape, a floppy disk, an optical data storage device, etc.

After considering the specification and practicing the examples disclosed herein, those skilled in the art will easily come up with other implementation solutions of the present disclosure. The present disclosure is intended to cover any variations, uses, or adaptive changes of the present disclosure, which follow the general principles of the present disclosure and include common knowledge or commonly used technical means in the technical field that are not disclosed in the present disclosure. The specification and examples are only considered illustrative, and the true scope and spirit of the present disclosure are indicated by the following claims.

It is to be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

1. A ranging method, comprising:
broadcasting, by a first terminal device, a ranging discovery message in response to a ranging service being triggered;
receiving, by the first terminal device, a ranging response message sent by a second terminal device based on the ranging discovery message; and
performing, by the first terminal device, ranging with the second terminal device based on the ranging response message.

2. The method according to claim 1, wherein the ranging discovery message comprises a first ranging service identifier, the ranging response message comprises a second ranging service identifier, and the performing ranging with the second terminal device based on the ranging response message comprises:
performing ranging with the second terminal device in response to the first ranging service identifier being consistent with the second ranging service identifier.

3. The method according to claim 1, wherein the broadcasting the ranging discovery message comprises:
obtaining an area of interest (AOI) parameter;
determining an AOI broadcast area based on the AOI parameter; and
broadcasting the ranging discovery message in the AOI broadcast area.

4. The method according to claim 3, wherein the broadcasting the ranging discovery message in the AOI broadcast area comprises:
determining, based on the AOI broadcast area, at least one of a broadcast beam direction or a broadcast power; and
broadcasting, based on the at least one of the broadcast beam direction or the broadcast power, the ranging discovery message.

5. The method according to claim 3, wherein the ranging discovery message carries the AOI parameter.

6. The method according to claim 1, wherein the broadcasting the ranging discovery message comprises:
obtaining an AOI parameter; and
broadcasting the ranging discovery message comprising the AOI parameter.

7. The method according to claim 1, wherein the ranging response message comprises an identifier of the second terminal device.

8. The method according to claim 3, wherein the AOI parameter comprises one or more of a distance parameter, an azimuth parameter, or an elevation direction parameter.

9. The method according to claim 1, wherein the ranging discovery message and the ranging response message comprise a line-of-sight transmission capability identifier.

10. A ranging method, comprising:
obtaining, by a first terminal device, an area of interest (AOI) parameter in response to a ranging service being triggered;
determining, by the first terminal device, an AOI broadcast area based on the AOI parameter; and
broadcasting, by the first terminal device, a ranging discovery message in the AOI broadcast area.

11. The method according to claim 10, wherein the broadcasting the ranging discovery message in the AOI broadcast area comprises:
determining, based on the AOI broadcast area, at least one of a broadcast beam direction or a broadcast power; and
broadcasting the ranging discovery message based on the at least one of the broadcast beam direction or the broadcast power.

12. The method according to claim 10, wherein the ranging discovery message carries the AOI parameter.

13. The method according to claim 10, wherein the AOI parameter comprises one or more of a distance parameter, an azimuth parameter, or an elevation direction parameter.

14. A ranging method, comprising:
receiving, by a second terminal device, a ranging discovery message broadcast by a first terminal device; and
sending, by the second terminal device, a ranging response message to the first terminal device.

15. The method according to claim 14, wherein each of the ranging discovery message and the ranging response message comprises a first ranging service identifier.

16. The method according to claim 14, wherein the ranging discovery message is broadcast in an area of interest (AOI) broadcast area.

17. The method according to claim 14, wherein the ranging discovery message comprises an AOI parameter, and the sending the ranging response message to the first terminal device comprises:
determining, based on the AOI parameter, whether the second terminal device conforms to the AOI parameter;
sending the ranging response message to the first terminal device in response to the second terminal device conforming to the AOI parameter;
not sending the ranging response message in response to the second terminal device not conforming to the AOI parameter.

18. The method according to claim 17, wherein the AOI parameter comprises one or more of a distance parameter, an azimuth parameter, or an elevation direction parameter.

19. The method according to claim 14, wherein the ranging discovery message and the ranging response message comprise a line-of-sight transmission capability identifier.

20-22. (canceled)

23. A terminal device, comprising:
a transceiver;
a memory; and
a processor, connected to the transceiver and the memory, wherein the processor, through executing a computer-executable instruction in the memory, is configured to control transmitting and receiving of a wireless signal of the transceiver, and is capable of implementing the method according to claim 1.

24. (canceled)
